(19) United States
(12) Patent Application Publication
(10) Pub. No.: US 2026/0199915 A1
(43) Pub. Date: Jul. 16, 2026

(54) ELECTROSTATIC SPRAYING SYSTEM FOR ELECTROSTATIC SPRAYING AN AREA OR SURFACE OF AN OBJECT

(71) Applicant: VAN LAER TECHNOLOGY B.V., Weert (NL)

(72) Inventor: Hubertus Joannes VAN LAER, Weert (NL)

(21) Appl. No.: 19/137,408

(22) PCT Filed: Dec. 12, 2023
(86) PCT No.: PCT/NL2023/050652

§ 371 Date: Jun. 10, 2025

(30) Foreign Application Priority Data
Dec. 12, 2022 (NL) 2033712

(51) Int. Cl. B05B 5/03; B05B 12/16

(52) U.S. Cl. CPC B05B 5/03; B05B 12/16

(57) ABSTRACT

The present invention relates to an electrostatic spraying system (10) for electrostatic spraying an object, the system (10) comprising an air-assisted electrostatic spraying device (14) and an airflow channel (12), wherein the spraying device (14) is positioned in the airflow channel (12) and comprises a spray nozzle (16), said spray nozzle (16) is configured to provide an electrostatically charged spray plume in the direction of the object. The airflow channel (12) is configured to provide an airflow in the direction of the object to be sprayed and successively comprises a first part comprising an air inlet, a second part for providing a venturi effect, and a third part comprising an air outlet. The air-assisted electrostatic spraying nozzle (16) is positioned in the third part of the airflow channel (12) and wherein the third part is configured to provide an airflow surrounding the electrostatically charged spray plume. The invention further relates to the use of the spraying system (10) and method.

The present invention relates to an electrostatic spraying system for electrostatic spraying an area or a surface of an object. The present invention further relates to the use of the electrostatic spraying system of the present invention and a method of providing an electrostatic spray to an area or a surface of an object.

Electrostatic spraying devices, such as spray-guns, are widely used in various applications. For example, spraying devices are used in electrostatic spray chilling systems in order to rapid cooling down foodstuffs. An example of such chilling system is disclosed in United States patent application US 2019/0254297 A1, wherein a chilled primary airflow is provided to a chilling tunnel to cooling down meat carcasses. As the carcasses are traversed through the chilling tunnel, spray modules generate and apply sprays of electrostatically charged fluid onto the carcasses.

Alternatively, electrostatic spray systems are used in methods for purifying polluted air containing pollutants. An example of such a purifying system is disclosed in International patent application WO 2022/139584 A1.

However, given the systems disclosed in the art, it was found that by application of higher airflow volumes, necessary for an improved cooling performance in a spray chilling system or an improved purifying performance in a purifying system, the effectiveness of the electrostatic spray provided by the electrostatic spraying device significantly reduced, in particular significantly reduced performance with higher flow velocities. Problems in relation to the attraction of sprayed electrostatic droplets, attracted by the steelwork constructions of the systems, was observed. Such attraction of electrostatic spraying droplets by the construction of the system resulted in larger droplets, which larger droplets accumulate, resulting in microbiological contamination, having a negative effect on the food safety of the chilling system.

Given the problems observed in the application of higher air volumes in various electrostatic spraying systems, the present invention now provides for an electrostatic spraying system wherein the problems identified are reduced or even solved. In order to do so, in a first aspect the present invention provides hereto an electrostatic spraying system for electrostatic spraying an area or a surface of an object, wherein the system comprises an air-assisted electrostatic spraying device and an airflow channel, wherein the air-assisted electrostatic spraying device is positioned in the airflow channel and wherein the air-assisted electrostatic spraying device comprises a spray nozzle, said spray nozzle is configured to provide an electrostatically charged spray plume in the direction of the area or surface to be sprayed.

The air-assisted electrostatic spraying device, e.g. a spray-gun or the like, used in the electrostatic spraying system of the present invention may be selected from any type of electrostatic spraying device. Air-assisted electrostatic spraying devices suitable for use in the electrostatic spraying device of the present invention may include a spraying device such as disclosed in United States patent application US 2019/0254297 A1. Commercially available air-assisted electrostatic spraying devices suitable for use in the electrostatic spraying device of the present invention may include the Pro Xpc Automatic Electrostatic Air Spray Gun line provided by Graco Inc., such as the 60 kV Spray Gun type LC2028, or the 100 kV Spray Gun type LC2020.

In particular, the air-assisted electrostatic spraying device used in the electrostatic spraying system of the present invention is configured to electrostatically charge the liquid for spraying inside the air-assisted electrostatic spraying device using a metal charging needle located in the centre of the spray nozzle. By having the liquid flowing along the needle, the liquid is electrostatically charged by conduction before leaving the spray nozzle of the air-assisted electrostatic spraying device. The metal charging needle may apply an electrical voltage of between 40 kV and 110 KV, preferably between 50 KV and 60 kV.

In a preferred embodiment of the present invention, the air-assisted electrostatic spraying device refers to a spraying device wherein an electrode, such as a cylindrical electrode, is located centrally in the spray nozzle of the spraying device, which electrode conductively charges the spray liquid when a high voltage is applied in order to produce an electrostatically charged spray plume. The electrode is surrounded by an annular nozzle through which the spray liquid is supplied. Multiple circular ‘primary’ air nozzles surround the liquid nozzle, aimed axially and inward to destabilise the liquid jet. Two ‘secondary’ air nozzles are located in the sprayer head of the nozzle, creating jets that impinge on the liquid at a near perpendicular angle.

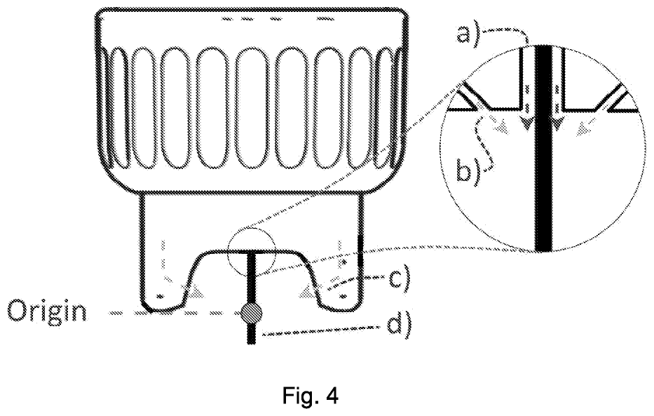

An example of such model is provided in FIG. 4. This model of sprayer head produces an oval fan-like spray profile, which may be adjusted by to a certain degree by varying the primary and secondary airflow. For that reason the primary and secondary air jets are also referred to as “atomisation” and “shaping” air, but in practice both play a role in the atomisation process. In standard operating conditions the liquid and air are supplied at 0.2 MPa gauge pressure, corresponding to 180 ml/min liquid flow and 425 standard litre [s]/min airflow.

The airflow channel of the spraying system of the present invention is configured to provide an airflow in the direction of the area or surface to be sprayed. The airflow channel may be made of any material, such as a metal or plastic. An airflow channel made of plastic, such as polyethylene (PE) or polytetrafluoroethylene (PTFE), is preferred. In particular, the use of an airflow channel made of PTFE is preferred due to its water repelling properties. As an electrostatically charged spray plume is provided by the spraying nozzle of the present invention, the use of a high electrical resistant and/or antistatic plastic material is preferred, e.g. a material selected from the group consisting of polyethylene (PE), polytetrafluoroethylene (PTFE) and combinations thereof.

The airflow channel of the electrostatic spraying system of the present invention successively comprises a first part, a second part and a third part, which parts are in fluid communication with each other (wherein the parts forming a continuous connection), and wherein:
the first part comprises an air inlet for supplying air into the airflow channel;
the second part comprises a restriction for providing a venturi effect on the airflow; and
the third part comprises an air outlet for the targeted discharge of air and the electrostatically charged spray plume provided by the spray nozzle from the airflow channel.

Given the design of the airflow channel of the present invention, in order to provide a highly efficient, well-balanced volume applying spraying system, the spray nozzle of the air-assisted electrostatic spraying device is positioned in the third part of the airflow channel, i.e. downstream the second part of the airflow channel comprising the restriction for providing a venturi effect on the airflow. In addition, the third part of the airflow channel is configured to provide an airflow surrounding the electrostatically charged spray plume provided by the spray nozzle of the air-assisted electrostatic spraying device. By providing such a configuration of the electrostatic spraying system of the present invention, each of the various elements of the electrostatic spraying system, i.e. the airflow and the electrostatically charged droplets of the electrostatically charged spray plume can be balanced such that a maximum transfer yield is provided and the risk of droplet adhesion to the airflow channel material is reduced or even eliminated.

Further it is noted that with the configuration of the electrostatic spraying system of the present invention, the settings of the supply of air into the airflow channel and/or the settings of the spraying device providing the electrostatically charged spray plume may be adjusted such that a balanced interconnection between the electrostatically charged spray plume and the airflow in the airflow channel can be provided. By balancing the interconnection of the airflow and the plume, the spraying system of the present invention provides for a highly efficient, well-balanced volume applying spraying system.

In addition, and in a preferred embodiment of the electrostatic spraying system of the present invention, the system is configured such that, in use, the system is able to direct a system surrounding airflow in the direction of the area or surface to be sprayed at the air outlet of the system. By directing the airflow of the air surrounding the electrostatic spraying system of the present invention to the area or surface to be sprayed, the system provides for a multi-flowing spraying system wherein various airflows coincide or are parallel to each other, i.e. the surrounding airflow coincides with or is parallel to the direction of the targeted discharge of air at the air outlet of the system. In such multi-flowing spraying system, the airflows of:
the air supplied into the airflow channel;
the air surrounding the electrostatically charged spray plume both discharged from the spray nozzle of the air-assisted electrostatic spraying device; and
the air surrounding the spraying system of the present invention.

Regarding the air surrounding the spraying system of the present invention it is noted that the spraying system may be positioned in a space wherein an airflow is created and wherein the spraying system is positioned such that the airflow of the air in the space is directed along the spraying system. Alternatively, the spraying system is positioned such that the airflow of the air in the space is directed to the spraying system under an angle, wherein the angle is selected such that the airflow of the air in the space coincides with or is parallel to the airflow exiting the air outlet of the spraying system in the direction of the surface of an object or area to be sprayed.

Alternatively, the spraying system of the present invention may be positioned in any space or environment wherein a natural airflow of the spraying system surrounding air is present. Any airflow, also airflows with a low speed, present surrounding the spraying system may be suitable for providing a multi-flowing spraying effect. Typically, the airflow of the spraying system surrounding air, i.e. the air at the outside of the airflow channel, has an airflow rate of about 0.5 m/s to about 4 m/s, preferably about 1 m/s to about 3 m/s, more preferably about 2 m/s.

The electrostatic spraying system of the present invention may further comprise an air acceleration unit placed in the first part of the airflow channel for increasing the speed of air supplied to the airflow channel. Any type of air acceleration unit may be used. Preferably, an air acceleration unit is used wherein the velocity of the airflow is increased with −50% to +400% compared to the average velocity of the airflow surrounding the airflow channel of the electrostatic spraying system. In a preferred embodiment, the airflow is increased with about +100% to about +300%, approximately with about +200% compared to the average velocity of the airflow surrounding the electrostatic spraying system. In absolute figures, the air acceleration unit may provide for an airflow with an airflow velocity of about 2.0 m/s to about 3.0 m/s, preferably a velocity of about 2.5 m/s.

The airflow channel of the electrostatic spraying system of the present invention may have any suitable form of an airflow channel. However, a cylindrical or elliptical chape of the airflow channel is preferred. In a preferred embodiment of the present invention, the airflow channel is in the form of a cylindrical or elliptical tube.

The third part of the airflow channel may have a diverging configuration in the downstream direction, i.e. a diverging configuration from the second part of the airflow channel in the direction of the air outlet of the airflow channel. It was found that the diverging configuration provides for an extension of the space for the electrostatically charged spray plume comprising repelling electrostatically charged droplets. By providing the diverging configuration, the electrostatically charge droplets at the periphery of the electrostatically charge plume do not collide with, or have minimal interaction with, the inner side wall of the airflow channel. In a preferred embodiment, the diverging configuration comprises a widened configuration, a parabolic configuration and/or a conical configuration. In particular, a parabolic configuration of the third part of the airflow channel is preferred, resulting in an airflow channel configuration wherein the adhesion of electrostatically charged droplets of the spray plume to the interior of the airflow channel is further reduced or even eliminated.

As stated above, the second part of the airflow channel of the electrostatic spraying system of the present invention comprises a restriction for providing a venturi effect on the airflow. The restriction may comprise a narrowing of the diameter of the airflow channel. In a preferred embodiment the restriction in the second part of the airflow channel comprises a partial tapered shaping of the airflow channel. It is noted that the position of the air-assisted electrostatic spraying device may already case a restriction in the second part of the airflow channel. As such, there is no need to actually change the dimensions and/or shape of the second part of the airflow channel.

The air outlet of the third part of the airflow channel may be further provided with a plurality of adjacent chevrons. The adjacent chevrons are preferable made of a material selected from the group consisting of antistatic, liquid repelling material and combinations thereof. By providing such configuration of the air outlet of the airflow channel, any unwanted electrostatically charged droplets formed on the interior of the airflow channel are easily removed from the system. In addition, by providing a plurality of adjacent chevrons, turbulence of the airflow discharged from the airflow channel is further reduced, and thus increasing the transfer yield of the electrostatically charged spray plume provided by the spray nozzle of the air-assisted electrostatic spraying device positioned within the airflow channel.

Regarding the positioning of the spray nozzle of the air-assisted electrostatic spraying device in the third part of the airflow channel, it was found that the spray nozzle of the air-assisted electrostatic spraying device is preferably positioned at some distance from the second part of the airflow channel. In a preferred embodiment of the present invention, the spray nozzle of the air-assisted electrostatic spraying device is positioned at 10-70% of the total length of the third part of the airflow channel measured from the second part of the airflow channel to the air outlet of the airflow channel. More preferred, the spray nozzle of the air-assisted electrostatic spraying device is positioned at 30-50%, even more preferred at approximately 40%, of the total length of the third part of the airflow channel measured from the second part of the airflow channel to the air outlet of the airflow channel.

The spray nozzle of the air-assisted electrostatic spraying device may have different states, i.e. having different spraying angles to perform different operations in different states. For example, the spray nozzle of the air-assisted electrostatic spraying device may:
have an operational spraying state, in which the primary angle of the electrostatically charged spray plume to be provided by the spray nozzle is 20°-50°, preferably 30°-40°, more preferably approximately 35°; and
have a maintenance state, in which the primary angle of the electrostatically charged spray plume to be provided by the spray nozzle is greater than the primary angle of the electrostatically charged spray plume to be provided by the spray nozzle in the operational spraying state.

By providing an operational spraying state and a maintenance state, the electrostatic spraying system is able to provide a cleaning and rinsing step before performing the next operational spraying activity.

In a second aspect of the present invention, the present invention relates to the use of the electrostatic spraying system according to the present invention for electrostatic spraying of an area or surface of an object, such as a foodstuff. In particular, the electrostatic spraying of an object, such as a foodstuff may include the use of the electrostatic spraying system according to the present invention for use in spray chilling of foodstuffs.

Although the electrostatic spraying system according to the present invention may be used in electrostatic spraying an area or a surface of an object, the present invention also relates to the use of the electrostatic spraying system according to the present invention for use in applying a coating, such as a paint layer, to a surface of an object.

Alternatively, the present invention relates to the use of electrostatic spraying system according to the present invention for use in an air treatment device for purifying polluted air, in particular polluted stable air. Such polluted air comprises contaminants, such as ammonia, dust particles and stench of volatile organic components.

In a third aspect of the present invention, the present invention relates to a method of providing an electrostatic spray to an area or a surface of an object, wherein the method comprises the steps of:
a) providing the electrostatic spraying system according to the present invention;
b) positioning the electrostatic spraying system provided in step a) such that an airflow surrounding the electrostatic spraying system is directed to the area or the surface of an object, wherein the direction of the system surrounding airflow coincides with or is parallel to the direction of the electrostatically charged spray plume leaving the outlet of the system; and
c) spraying the area or the surface of an object.

The present invention will be further elucidated on the basis of the non-limitative exemplary embodiments shown in the following figure. Wherein:

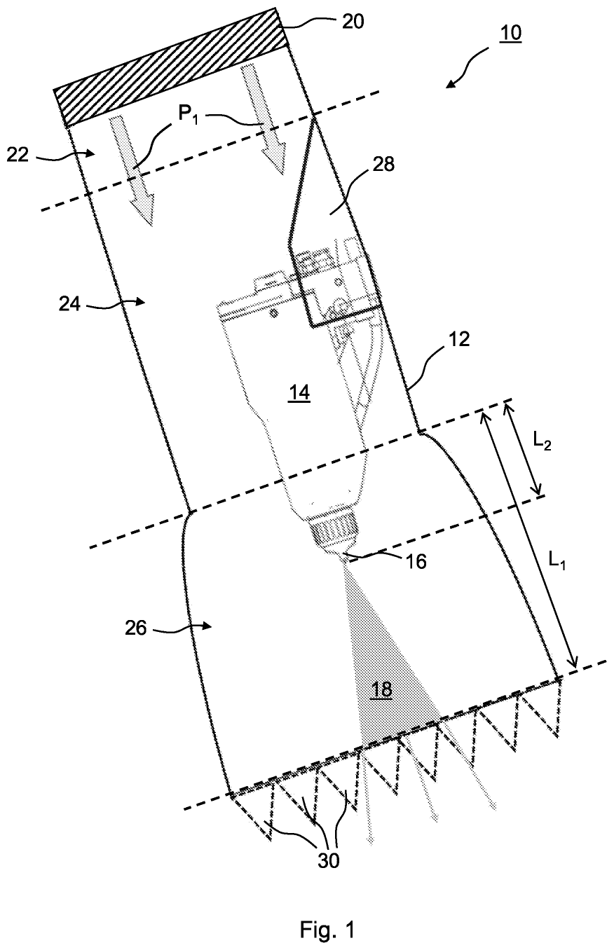

FIG. 1 is a schematic longitudinal cross-sectional view of a spraying system of the present invention;

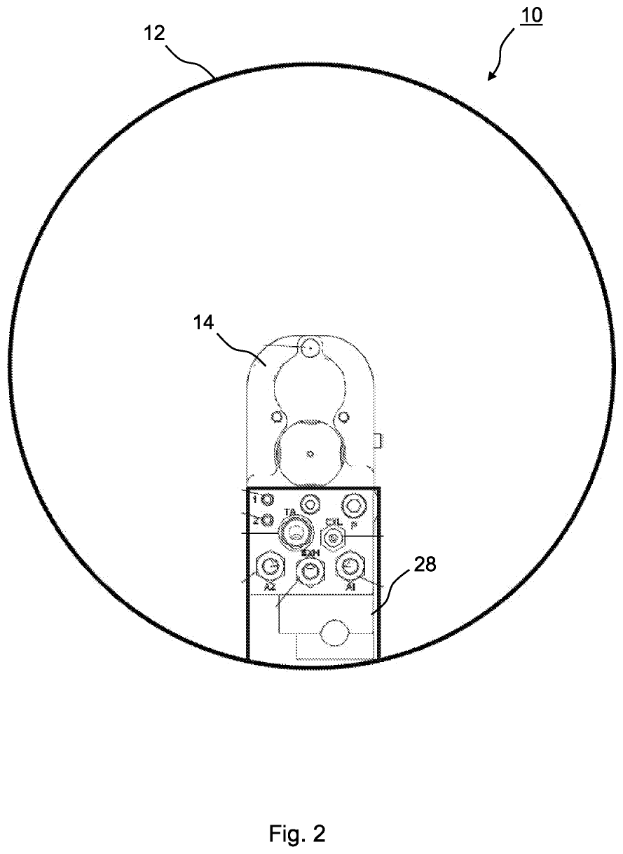

FIG. 2 is a cross-sectional view of a spraying system of the present invention;

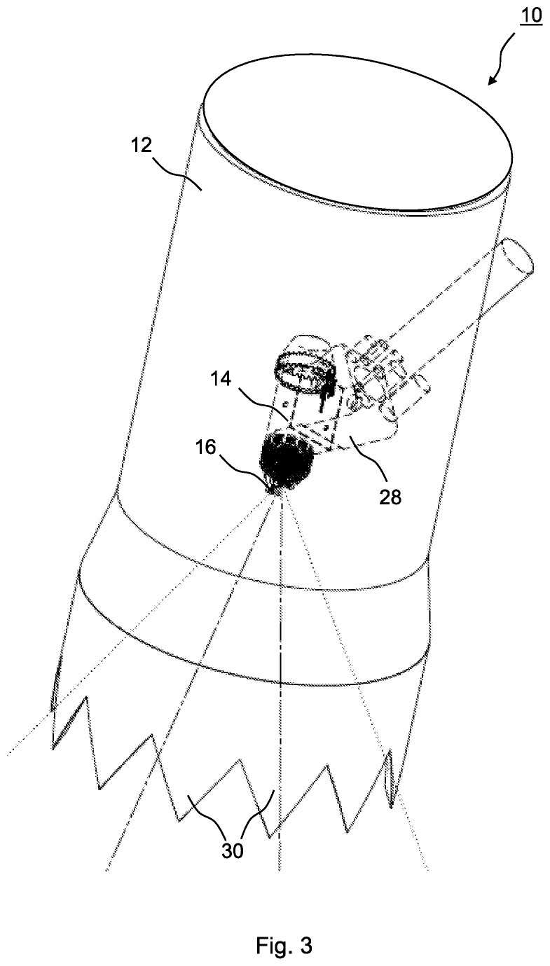

FIG. 3 is a perspective view of a spraying system of the present invention;

FIG. 4 is a schematic view of the nozzle of a spraying device used in the system of the present invention; and

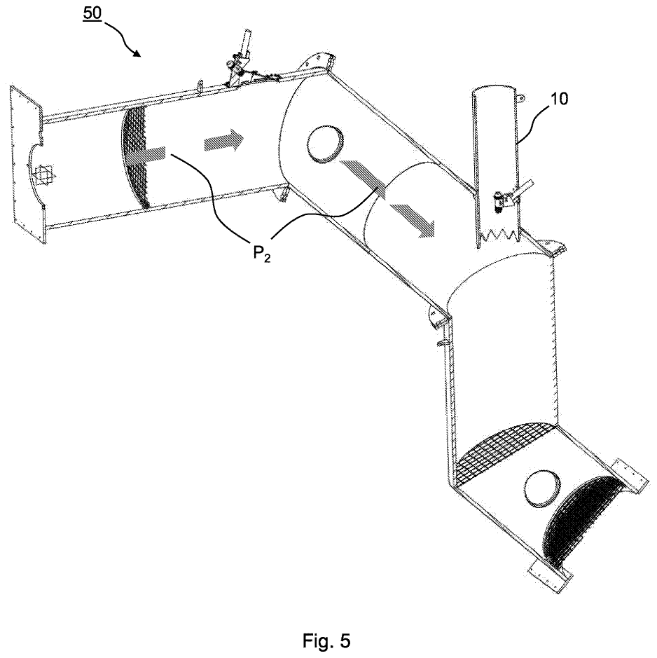

FIG. 5 is a perspective longitudinal cross-sectional view of an air treatment system comprising the spraying system of the present invention.

FIG. 1 shows a schematic longitudinal cross-sectional view of an embodiment of the electrostatic spraying system 10 of the present invention. The system 10 comprises an airflow channel 12 and an air-assisted electrostatic spraying device 14 comprising a spray nozzle 16 configured to provide an electrostatically charged spray plume 18. The airflow channel 12 further comprises an airflow acceleration unit 20 for increasing the velocity of the airflow (indicated by arrows P₁) in the airflow channel 12. The airflow channel 12 is further divided into three different parts, the first part 22, the second part 24 and the third part 26. The second part 24 of the airflow channel 12 is provided with a restriction 28 in order to provide, together with the air-assisted electrostatic spraying device 14, a venturi effect on the airflow comprised in the airflow channel 12. The spray nozzle 16 produces a flow of electrostatically charged droplets. The electrostatically charged droplets form a charged spray-plume 18 in combination with the airflow produced by the air-assisted electrostatic spraying device 14. The electrostatically charged spray plume 18 is in a balanced interconnection with the airflow P₁ of the airflow channel 12. The air outlet of the third part 26 is provided with a plurality of adjacent chevrons 30. The spray nozzle 16 of the air-assisted electrostatic spraying device 14 is positioned at a distance L₂ measured from the second part 24 of the airflow channel 12. The position of the spray nozzle 16 of the air-assisted electrostatic spraying device 14 is preferably indicated by the percentage (i.e. ratio L₂/L₁) in relation to the total length of the third part 26 indicated by length L₁.

FIG. 2 shows a cross-sectional view of the spraying system 10 similar to the electrostatic spraying system 10 as depicted in FIG. 1. FIG. 2 shows the airflow channel 12, the restrictor 28 and the air-assisted electrostatic spraying device 14, wherein the restrictor 28 and the air-assisted electrostatic spraying device 14 are together providing the venturi effect in the airflow channel 12.

FIG. 3 shows a perspective view of an electrostatic spraying system 10 similar to the electrostatic spraying system 10 as depicted in FIG. 1. In the electrostatic spraying system 10 of FIG. 3, the airflow channel 12 has a slightly different configuration regarding the third part of the airflow channel 12. The electrostatic spraying system 10 of FIG. 3 further depicts the air-assisted electrostatic spraying device 14 and the spray nozzle 16 of the air-assisted electrostatic spraying device 14, as well as the restriction 28 and the chevrons 30.

FIG. 4 shows a schematic view of the nozzle of a spraying device used in the system of the present invention. In FIG. 4 water is injected through annular nozzle-opening (a), surrounding a conductive needle electrode (d). “Primary” air jets (b) initiate the breakup of the water surface of the water flow, coming from the nozzle-opening (a), while “secondary” air jets (c) assist the atomisation process and shape the spray into an oval fan.

FIG. 5 shows a perspective longitudinal cross-sectional view of an air treatment system 50 comprising the spraying system 10 of the present invention. The spraying system 10 of the present invention is positioned in the channel of the air treatment system 50 such that the airflow (indicated by arrows P₂) is directed to the spraying system 10 under a certain angle (in this case about 135°). By providing the configuration as shown in FIG. 5, the airflow of the channel of the air treatment system 50 coincides with the direction of the targeted discharge of air at the air outlet of the spraying system 10. As such providing a multi-flowing electrostatic spraying configuration at the air outlet of the spraying system 10. It is further noted that the air treatment system 50 as depicted in FIG. 5 is similar to the air treatment system disclosed in the International patent application published under number WO 2022/139584 A1.

### Experiments

The droplet transfer efficiency of electrostatic charged droplets was calculated using computational fluid dynamics analysis. The transfer efficiency using the spraying system of the present invention (named COFLOW channel) was compared with the transfer efficiency using the state of the art (air-guiding baffles). The results are presented in table 1 below.

TABLE 1
Droplet transfer efficiency

| | Airflow | Airflow | Reynolds | Spray | Transfer |
|---|---|---|---|---|---|
| | volume | velocity | number | charge | efficiency |
| Spray method | [m³/h] | [m/s] | [—] | [kV] | [%] |
| Air-guiding baffles | 4,000 | 1.2 | 160,000 | 60 | 32.0 |
| COFLOW channel | 400 | 2.6 | 44,000 | 60 | 56.6 |

The airflow volume and airflow velocity as identified in table 1 above, is the airflow volume and velocity in the second part of the airflow channel, i.e. the airflow surrounding the spraying device. For the COFLOW channel, the velocity of the airflow surrounding the airflow channel was about 0.5 to 4.0 m/s and the velocity of the airflow in the third part of the airflow channel was about 2.0 to 3.0 m/s.

Given the results as provided in table 1, it was demonstrated that with 1/10 of the amount of air, a better airflow velocity was obtained, with significant less turbulence (lower Reynolds number) resulting in an almost doubled droplet transfer efficiency.

1. An electrostatic spraying system for electrostatic spraying an area or a surface of an object, the system comprising an air-assisted electrostatic spraying device and an airflow channel, wherein the air-assisted electrostatic spraying device is positioned in the airflow channel and wherein the air-assisted electrostatic spraying device comprises a spray nozzle, said spray nozzle is configured to provide an electrostatically charged spray plume in the direction of the area or surface to be sprayed,
wherein the airflow channel is configured to provide an airflow in the direction of the area or surface to be sprayed and wherein the airflow channel successively comprises a first part, a second part and a third part, which parts are in fluid communication with each other, and wherein:
the first part comprises an air inlet for supplying air into the airflow channel;
the second part comprises a restriction for providing a venturi effect on the airflow; and
the third part comprises an air outlet for the targeted discharge of air and the electrostatically charged spray plume provided by the spray nozzle from the airflow channel,
wherein the spray nozzle of the air-assisted electrostatic spraying device is positioned in the third part of the airflow channel and wherein the third part of the airflow channel is configured to provide an airflow surrounding the electrostatically charged spray plume provided by the spray nozzle of the air-assisted electrostatic spraying device.

2. The electrostatic spraying system according to claim 1, wherein the system is configured to, in use, direct a system surrounding airflow in the direction of the area or surface to be sprayed at the air outlet of the system, wherein the direction of the surrounding airflow coincides with or is parallel to the direction of the targeted discharge of air at the air outlet of the system.

3. The electrostatic spraying system according to claim 1, wherein the system further comprises an air acceleration unit placed in the first part of the airflow channel for increasing the speed of air supplied to the airflow channel.

4. The electrostatic spraying system according to claim 1, wherein the airflow channel is a cylindrical or elliptical tube.

5. The electrostatic spraying system according to claim 1, wherein the third part of the airflow channel has a diverging configuration from the second part, including at least one of a widened configuration, a parabolic configuration and/or a conical configuration.

6. The electrostatic spraying system according to claim 1, wherein the restriction in the second part of the airflow channel comprises:
a narrowing of the diameter of the airflow channel;
a narrowing of a flow space of the airflow of the airflow channel; and/or
a partial tapered shaping of the airflow channel.

7. The electrostatic spraying system according to claim 1, wherein the outlet of the third part of the airflow channel is further provided with a plurality of adjacent chevrons.

8. The electrostatic spraying system according to claim 1, wherein the spray nozzle of the air-assisted electrostatic spraying device is positioned in the third part of the airflow channel and wherein the spray nozzle of the air-assisted electrostatic spraying device is positioned at some distance from the second part of the airflow channel.

9. The electrostatic spraying system according to claim 1, wherein the spray nozzle of the air-assisted electrostatic spraying device is positioned at 10-70% of the total length of the third part of the airflow channel measured from the second part of the airflow channel to the air outlet of the airflow channel.

10. The electrostatic spraying system according to claim 1, wherein the spray nozzle of the air-assisted electrostatic spraying device:
has an operational spraying state, in which the primary angle of the electrostatically charged spray plume to be provided by the spray nozzle is 20°-50°; and
has a maintenance state, in which the primary angle of the electrostatically charged spray plume to be provided by the spray nozzle is greater than the primary angle of the electrostatically charged spray plume to be provided by the spray nozzle in the operational spraying state.

11. The method according to claim 15, wherein the object is a foodstuff.

12. The method according to claim 11, wherein the spraying is used for of foodstuffs.

13. The method according to claim 15, wherein the spraying is used for applying a coating to the surface of an object.

14. Use according to claim 11 for use in an air treatment device for purifying polluted air, wherein the polluted air comprises contaminants, such as ammonia, dust particles and stench of volatile organic components.

15. A method of providing an electrostatic spray to an area or a surface of an object, wherein the method comprises the steps of:
a) providing the electrostatic spraying system according to claim 1;
b) positioning the electrostatic spraying system provided in step a) such that an airflow surrounding the electrostatic spraying system is directed to the area or the surface of an object, wherein the direction of the system surrounding airflow coincides with or is parallel to the direction of the electrostatically charged spray plume leaving the outlet of the system; and
c) spraying the area or the surface of an object.

16. The electrostatic spraying system according to claim 1, wherein the air-assisted electrostatic spraying device is positioned at 30-50% of the total length of the third part of the airflow channel measured from the second part of the airflow channel to the air outlet of the airflow channel.

17. The electrostatic spraying system according to claim 1, wherein the air-assisted electrostatic spraying device is positioned approximately 40% of the total length of the third part of the airflow channel measured from the second part of the airflow channel to the air outlet of the airflow channel.

18. The electrostatic spraying system according to claim 10, wherein the primary angle of the electrostatically charged spray plume to be provided by the spray nozzle is 30°-40°, more preferably approximately 35°.

19. The electrostatic spraying system according to claim 10, wherein the primary angle of the electrostatically charged spray plume to be provided by the spray nozzle is approximately 35°.

20. The method according to claim 13, wherein the coating is a paint layer.
